(19) United States
(12) Patent Application Publication
(10) Pub. No.: US 2009/0289393 A1
(43) Pub. Date: Nov. 26, 2009

(54) Method of Producing Outer Covering on a Housing of Product

(76) Inventor: Hung Ming Chen, Taipei (TW)

Correspondence Address: TROXELL LAW OFFICE PLLC, SUITE 1404, 5205 LEESBURG PIKE, FALLS CHURCH, VA, 22041, US

(21) Appl. No.: 12/126,458

(22) Filed: May 23, 2008

(51) Int. Cl. B29C 43/00

(52) U.S. Cl. 264/295

(57) ABSTRACT

Disclosed is a method of producing outer covering on a housing of product. A thermosetting adhesive is respectively applied to the inner surface of a flexible covering layer and the outer surface of a housing, and the thermosetting adhesive is dried after being applied thereto. The flexible covering layer and the housing are superimposed and disposed into the lower mold half of a mold, wherein the thermosetting adhesives are softened by a heat and pressure treatment during an assembling process of the lower mold half and a upper mold half, so as to adhere firmly the flexible covering layer to the housing used for consumer electronics.

### FIELD OF THE INVENTION

The present invention relates to a method of producing outer covering on a housing of electronic device, and more particularly, to a method for tightly adhering a flexible covering layer to a housing of consumer electronics by heat and pressure treatment in a mold.

### DESCRIPTION OF THE PRIOR ART

The faceplates of 3C products in the market are usually manufactured by spraying or sputtering a protective layer on the surface of a housing made by plastic, aluminum alloy, or acrylic material, By the method mentioned above, only faceplates of different colors can be manufactured and it fails to produce faceplates with grain top made by different wood, fabric, or leather. Therefore, the faceplates produced by the above method can not produce three-dimensional visual effect.

In order to solve the problem mentioned above, some manufacturers have attached fabric, metal, leather or woody material to a housing surface formed unique three-dimensional grains on the surface of a faceplate. For example, leather can be covered around the surface of a housing for producing beautiful leather grains and desired tactile sense. However, covering the leather around the surface of the housing needs to proceed by several steps to fix the leather on the surface of the housing because of the soft property of different kinds of leather, such as fur-skins or artificial leather. Consequently, the cost of production is increased.

Besides, the leather and the housing can be adhered with each other, but the adhering force for sticking the leather on the housing is not tight because the leather and the housing are made of different types of material. Therefore, the leather may easily detach from the housing because of the decreasing of the adhering force or the inherent tension of the leather after a long period time of use.

In order to solve the problems mentioned above and to simplify the procedures of manufacturing a leather decorative plate, also to ensure the quality of the produced leather decorative plate, at the same time to increase the yield rate and reduce the manufacturing cost inventor had the motive to study and develop the present invention after hard research.

### SUMMARY OF THE INVENTION

The primary object of the present invention is to provide a method of producing outer covering on a housing of product. By applying a thermosetting adhesive to the inner surface of a flexible covering layer and the outer surface of a housing respectively, wherein the flexible covering layer is shaped and adhered onto the housing by a heat and pressure treatment for producing beautiful leather grains on the surface of portable electronic devices, such as 3C products, attract consumer attention for promoting the sale. At the mean time, the manufacturing cost can be reduced accordingly.

A secondary object of the present invention is to provide a method of producing outer covering on a housing of product, wherein the air between a flexible covering layer and the housing is removed by drawing vacuum or by compressing gradually the flexible covering layer with an elastic member so as to adhere firmly the flexible covering layer to the housing by this way for ensuring the quality of finished products.

In order to achieve the above objects, the method of making outer covering on a housing of product comprises the steps of: (a) providing a flexible covering layer and a housing; (b) applying a thermosetting adhesive to the inner surface of the flexible covering layer and the outer surface of the housing respectively; and (c) superimposing the flexible covering layer on the housing, and disposing the housing superposed with the flexible covering layer into a mold for adhesion, wherein the flexible covering layer is shaped on the housing by softening the thermosetting adhesive under heat and pressure treatment provided in the mold.

According to the present invention, the thermosetting adhesive is made by mighty glue, polyurethane adhesives, acrylic glue or the like.

According to the present invention, a vacuum is drawn in the interior of the mold prior to the heat and pressure treatment.

According to the present invention, the mold includes an upper mold half and a lower mold half having a cavity for receiving the flexible covering layer and the housing, wherein the upper mold half has an elastic member being formed in a convex shape and protruding downward for gradually extruding air between the flexible covering layer and the housing when closing the mold.

According to the present invention, an elastic member is disposed in the cavity of the lower mold half for extruding gradually air between the flexible covering layer and the housing so as to prevent air from accumulating there between to ensure the finish quality.

The present invention will be apparent after reading the detailed description of the preferred embodiments in reference to the accompanying drawings.

### BRIEF DESCRIPTION OF THE DRAWINGS

FIG. 1 illustrates a flowchart of the preferred embodiment of the method of producing outer covering on a housing of product according to the present invention.

FIG. 2 illustrates a perspective view of the preferred embodiment showing the elements according to the present invention.

FIG. 3 illustrates a sectional view showing the upper mold half having a downward-protruding elastic member and the lower mold half during an assembling process.

FIG. 4 illustrates a sectional view showing the upper mold half and the lower mold half having a downward-protruding elastic member when the mold is closed.

FIG. 5 illustrates a sectional view showing the upper mold half and the lower mold half having a downward-protruding elastic member during an assembling process.

### DETAILED DESCRIPTION OF THE PREFERRED EMBODIMENT

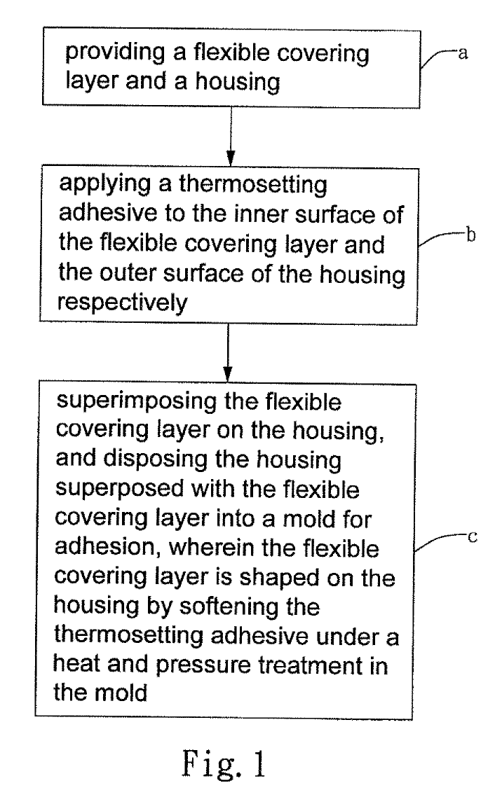

Referring to FIG. 1, there is illustrated a preferred embodiment of a method of making outer covering on a housing of product of the present invention. The method comprises the steps of:
(a) providing a flexible covering layer and a housing;
(b) applying a thermosetting adhesive to the inner surface of the flexible covering layer and the outer surface of the housing respectively; and
(c) laying over the flexible covering layer on the housing, disposing the housing superposed with the flexible covering layer into a mold for adhesion, wherein the flexible covering layer is shaped on the housing by softening the thermosetting adhesive under heat and pressure treatment in the mold.

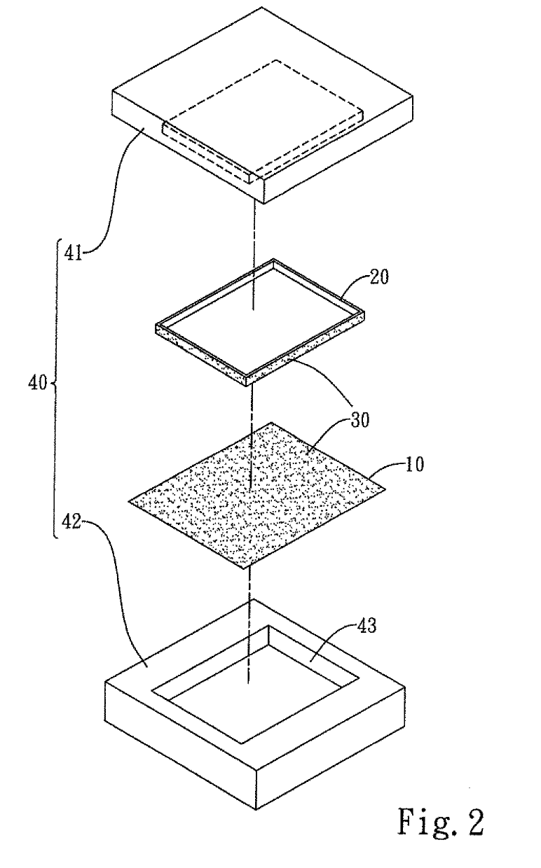

Referring to FIG. 2, the flexible covering layer 10 of the step (a) mentioned above is made of planar knit fabric, fur-skins, artificial leather or materials with flexible property. The housing 20 is a rectangle box formed by plastic injection molding, and it can be used for an upper cover of a laptop computer. In addition, the housing 20 can also be shaped to any different three-dimensional structure to form an upper cover for consumer electronics, such as a computer mouse, a computer keyboard, a personal digital assistant, a MP3 player and the like.

The thermosetting adhesive 30 of the step (b) mentioned above is made by polyurethane adhesives, wherein the polyurethane adhesives on the inner surface of the flexible covering layer 10 and the outer surface of the housing 20 is dried after applied thereto. The dried treatment is processed by natural drying of the thermosetting adhesive 30 at room temperature or by roasting the thermosetting adhesive 30 at a temperature lightly higher than room temperature. Thus, the dried thermosetting adhesive 30 does not show the viscid property. In practice, the thermosetting adhesive 30 can also be made by mighty glue, acrylic glue, or adhesives with the same property.

The mold 40 of the step (c) mentioned above includes an upper mold half 41 and a lower mold half 42 having a cavity 43 for receiving the flexible covering layer 10 and the housing 20, wherein the housing 20 is superimposed above the inner surface of the flexible covering layer 10. In addition, the bottom of the upper mold half 41 is shaped as the same with the external shape of the outer surface of the housing 20 so as to compress the flexible covering layer 10 and the housing 20 in an assembling process for the upper mold half 41 and the lower mold half 42. Additionally, the lower mold half 42 is pre-heated for softening the thermosetting adhesives 30 on the flexible covering layer 10 and the housing 20 so as to firmly adhere the flexible covering layer 10 to the housing 20 after the thermosetting adhesives 30 is cooled.

In practice, in the step (c), a vacuum is drawn in the interior of the mold 40 prior to the heat and pressure treatment, and thereby the flexible covering layer 10 is shaped and adhered onto the housing 20 in an airless environment to prevent bubbles which is formed between the flexible covering layer 10 and the housing 20.

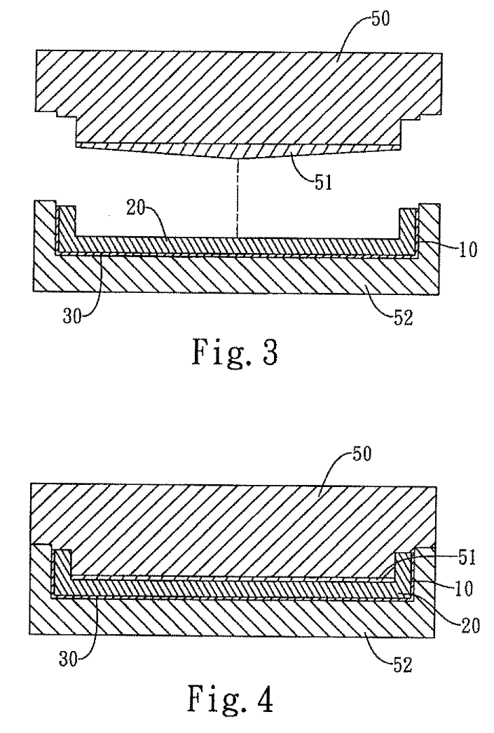

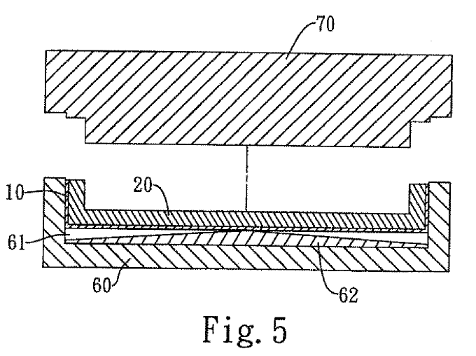

Referring to FIGS. 3 and 4, in addition to prevent bubbles formed between the flexible covering layer 10 and the housing 20 by vacuum drawing mentioned above, the following description is now provided about a mold 40 structure for extruding air between the flexible covering layer 10 and the housing 20 wherein a elastic member 51 is disposed in the central part of the bottom of the upper mold half 50. The elastic member 51 is formed in a convex shape and protruding downward, by this way the bottom of the elastic member 51 can touch the inner surface of the housing 20 first when assembling the upper mold half 50 and the lower mold half 52, gradually expand the contact area by the deformation property of the elastic member 51, and compress the flexible covering layer 10 and the housing 20 for extruding air.

In practice, another elastic member 62 may be also disposed in the cavity 61 of the lower mold half 60. The elastic member 62 is formed in a convex shape and protruding upward for gradually extruding air between the flexible covering layer 10 and the housing 20 when the upper mold half 70 and the lower mold half 60 assembles, and thereby the flexible covering layer 10 and the housing 20 can be adhered firmly for ensuring the finish quality.

Therefore, the present invention has following advantages:
1. The knit fabric can be directly shaped and adhered onto the housing of consumer electronics to show three-dimensional grains thereon to attract consumer attention and promote the sale, and the manufacturing cost can be reduced accordingly.
2. The present invention can effectively eliminate the bubbles that may be formed between the flexible covering layer and the housing to adhere firmly the flexible covering layer to the housing, which ensure the finish quality.
3. The thermosetting adhesives on the flexible covering layer and the housing are dried to disable its viscidity for facilitating the preparation of adhesion, and the irreversible attachment provides a strong adhesion force to prolong the life of usage.

It should be understood that different modifications and variations could be made from the disclosures of the present invention by the people familiar in the art, which should be deemed without departing the spirit of the present invention.

What is claimed is:

1. A method of making outer covering on a housing of product, comprising the steps of:
(a) providing a flexible covering layer and a housing;
(b) applying a thermosetting adhesive to the inner surface of the flexible covering layer and the outer surface of the housing respectively; and
(c) superimposing the flexible covering layer on the housing, and disposing the housing superposed with the flexible covering layer into a mold for adhesion, wherein the flexible covering layer is shaped on the housing by softening the thermosetting adhesive under a heat and pressure treatment in the mold.

2. The method as claimed in claim 1, wherein the flexible covering layer is made by fur-skins or artificial leather.

3. The method as claimed in claim 1, wherein the flexible covering layer is made by knit fabric.

4. The method as claimed in claim 1, wherein the thermosetting adhesive is made by polyurethane adhesives, or acrylic glue.

5. The method as claimed in claim 1, wherein the thermosetting adhesive on the inner surface of the flexible covering layer and the outer surface of the housing is dried after applied thereto.

6. The method as claimed in claim 1, wherein a vacuum is drawn in the interior of the mold prior to the heat and pressure treatment.

7. The method as claimed in claim 1, wherein the mold includes an upper mold half and a lower mold half having a cavity for receiving the flexible covering layer and the housing, wherein the upper mold half has an elastic member being formed in a convex shape and protruding downward for gradually extruding air between the flexible covering layer and the housing.

8. The method as claimed in claim 1, wherein the mold includes an upper mold half and a lower mold half having a cavity for receiving the flexible covering layer and the housing, wherein the lower mold half has an elastic member being formed in a convex shape and protruding upward for gradually extruding air between the flexible covering layer and the housing.

9. The method as claimed in claim 5, wherein a vacuum is drawn in the interior of the mold prior to the heat and pressure treatment.

10. The method as claimed in claim 5, wherein the mold includes an upper mold half and a lower mold half having a cavity for receiving the flexible covering layer and the housing, wherein the upper mold half has an elastic member being formed in a convex shape and protruding downward for gradually extruding air between the flexible covering layer and the housing.

11. The method as claimed in claim 5, wherein the mold includes an upper mold half and a lower mold half having a cavity for receiving the flexible covering layer and the housing, wherein the lower mold half has an elastic member being formed in a convex shape and protruding upward for gradually extruding air between the flexible covering layer and the housing.
